(19) United States
(12) Patent Application Publication
(10) Pub. No.: US 2002/0083435 A1
(43) Pub. Date: Jun. 27, 2002

(54) Method and system for addressing targeted advertisements using detection of operational status of display device

(76) Inventors: John P. Blasko, New Hope, PA (US); Charles A. Eldering, Doylestown, PA (US)

Correspondence Address: EXPANSE NETWORKS, INC., 300 NORTH BROADSTREET, DOYLESTOWN, PA, 18901, US

(21) Appl. No.: 09/731,605

(22) Filed: Dec. 7, 2000

Related U.S. Application Data
(60) Provisional application No. 60/229,156, filed on Aug. 31, 2000.

(51) Int. Cl. H04N 7/16; H04H 9/00; G06F 17/60; H04N 7/025; H04N 7/10

(52) U.S. Cl. 725/14; 725/32; 725/15; 705/14

(57) ABSTRACT

A system and method are disclosed for addressing targeted advertisements using a detection of the on/off operational status of a display device. The method includes determining whether or not the display device (e.g., a TV) of a subscriber of a TV programming service is operating, and inserting the advertisements into at least one media stream if it is determined that the display device is operating. Targeted advertisements are inserted into the programming stream only if the subscriber's display device is turned on to actually display the inserted advertisements. In this manner, advertisers can more specifically reach their target audience while also being given a much higher level of confidence that their ads have actually been viewed by the target audience.

### RELATED APPLICATION

This patent application claims priority of U.S. Provisional Patent Application No. 60/229,156 filed on Aug. 31, 2000, owned by the same assignee of the present invention, and entitled “Method and System for Addressable and Program Independent Advertising,” which is incorporated herein by reference.

### BACKGROUND OF THE INVENTION

1. Field of the Invention

The invention pertains to advertising. More particularly, the invention pertains to targeted advertising, such as in television programming delivery systems utilizing set top boxes for each subscriber.

2. Discussion of the Related Art

The traditional paradigm for delivering advertisements in the stream of television programming is herein termed linked advertising. Whether the television programming service is being provided by land-based analog antenna broadcast, analog cable, digital broadcast satellite (DBS), digital cable, switched digital video (SDV) or any other means, generally all viewers of a particular program will see the same ads in the same order at the same times. In essence, each advertisement is “linked” to a particular point within a particular program. If any particular viewer is not viewing the particular program at the particular time, he or she will not see the advertisement. That is, in linked advertising, the advertisements are simply part of the data stream from the head end, i.e., from the central office of the television service provider to all subscribers of that service.

However, with modern digital television service methods, including SDV systems (in which television service is received over the telephone lines) via very high speed digital subscriber line (VDSL), which utilizes the concept of addressable set top boxes (STBs) which are coupled to the front end of the subscriber's television and process the data stream before forwarding a channel of it to the television, more personalized service is now available. For instance, two-way communication between the subscriber's set top box and the service provider via the network is possible. Further, the service provider can send different data to different subscribers. For instance, in telephone based systems such as SDV, the service provider can actually send different information to any individual subscriber. In most digital cable systems, different data can be sent to different groups of subscribers through cable nodes on the system, each node servicing a plurality of subscribers (usually a few hundred).

Using these modern digital television service methods, better targeted TV advertising is possible. In targeted TV advertising, advertisements that have been selected or prepared to interest particular subscribers identified, for instance, using geo-demographic information, are inserted into TV programming streams for the identified subscribers by a TV service provider such that different viewers of the same television program view different advertisements that are particularly directed to them. Further, ad selection and insertion can occur at the household level wherein each household ad insertion device (e.g., a STB) receives a plurality of ads from an ad source, such as the network, and selects ads that are most appropriate for the viewer in the household based on predetermined ad selection criteria. The ad insertion device inserts the selected ads into programming streams for display. PCT Patent Publication No. WO 99/66719 entitled “Techniques for Intelligent Video Ad Insertion” discloses one such scheme. The disclosure of that application is herein fully incorporated by reference.

In these targeted TV advertising systems, as long as the ad insertion device (e.g., a STB) is turned on, ads can still be received from the network and can be inserted into programming streams. However, a subscriber may leave the STB turned on, but the television turned off such that the subscriber does not actually view ads that are being inserted.

Accordingly, it is an object of the present invention to provide an improved method and system for delivering targeted advertising via a network, such as a television service network, wherein the insertion of targeted advertisements into the television program stream occurs based on a detection of whether or not a display device (e.g., a TV) is turned on, which ensures that the inserted ads are actually displayed to the viewer.

It is another object of the present invention to provide a method and system by which targeted advertisements can be inserted into the television program stream at the subscriber's side.

It is a further object of the present invention to provide a method and system for addressing targeted advertisements to individual subscribers or groups of subscribers on a network.

### SUMMARY OF THE INVENTION

In accordance with the present invention, subscribers to a particular television service, such as a cable television network, have set top boxes (STBs) for receiving multiple television programming channels offered by the television service provider. The channels carry programs and openings (or avails) interspersed among the programs specifically designated for the insertion of ads.

The advertisements to be inserted into the avails of the programming channels can be stored at the head end or at the subscriber's side such as in the set top box of the subscriber. The advertisements may also be stored at a remote server on the communications network, as long as the set top box can access the advertisements for insertion into the avails.

The set top box includes an ad processing unit coupled to a subscriber's display device, e.g., a TV or computer monitor. The ad processing unit detects the presence of avails in the programming channel. The ad processing unit also determines the next ad or ads to be inserted into the upcoming avails of the programming channel, and the order in which these ads are to be inserted into the programming channel. This determination can be made based on scheduling instructions received from the head end system or ad ordering and selection algorithms resident in the STB. The ad processing unit further includes an ad insertion module for inserting the ads into the upcoming avails of the programming channel according to the ad insertion schedule.

In accordance with one embodiment, the ad processing unit may include a display device operational status (DDOS) detector for detecting whether or not the subscriber's display device is operating, i.e., turned on. This detection is used by the ad insertion module to ensure that the ads are inserted into the avails only when the display device is turned on. The DDOS detector may reside in the set top box and can be directly or indirectly (e.g., inductively) connected to the display device for performing this detection. In accordance with another embodiment, the DDOS detector may be a separate device coupled between the subscriber's set top box and the display device.

When the presence of an avail in the programming stream is detected by the ad processing unit, the DDOS detector determines whether or not the subscriber's display device is turned on. If the DDOS detector indicates to the ad insertion module that the display device is turned on, the ad insertion module inserts the advertisements into the avails of the programming stream according to the ad insertion schedule. However, if the DDOS detector indicates that the display device is not turned on, which indicates that no one is watching the display device, then the ad insertion module does not insert the ads into the programming stream.

In accordance with the present invention, targeted advertisements are inserted into the programming stream only if the display device is turned on. This ensures that the advertisements are not inserted when it is certain that no one is watching the display device (i.e., when the display device is turned off). Thus the present invention increases the effectiveness of targeted advertising and offers greater assurance to the advertisers that their ads were actually watched by the subscribers.

While the invention is particularly suitable for inserting targeted advertisements into television programming, the invention is readily adaptable to inserting any particular data into any particular stream of other data transmitted via a communications system, which are to be displayed on a display device.

Other objects and advantages of the present invention will be set forth in part in the description and the drawings which follow, and, in part, will be obvious from the description or may be learned by practice of the invention.

### BRIEF DESCRIPTION OF THE DRAWINGS

FIG. 1 is a block diagram of an environment in which the present invention may be utilized.

FIG. 2 is a functional block diagram illustrating advertisement insertion according to one embodiment of the present invention.

FIG. 3 is a logic diagram illustrating an advertisement queue stored in memory in accordance with the present invention.

### DETAILED DESCRIPTION OF THE PREFERRED EMBODIMENTS

In this specification, a “subscriber” includes a viewer, a household, a user, or any entity that has the capability of receiving the advertisements from advertisers according to the present invention. A “subscriber system” is a system at the subscriber's end which receives, processes, and/or displays media signals (e.g., TV Programs) including advertisement signals on a display device, such as a TV or a computer monitor. Examples of the subscriber system may include, but are not limited to, an entertainment system (e.g., TV, VCR, personal video recorder (PVR), etc.) including or coupled to a set top box (STB) or the like, a personal computer, or a computer work station. A “head end system” is a system that originates the media signals and directs them to the subscriber systems. Examples of the head end system may include, but are not limited to, service providers such as a television service provider, e.g., ABC television network, a local cable television network operator, a cable television service provider, or an Internet service provider.

The media signals communicated between the head end system and the subscriber systems can be digital (e.g., MPEG) or analog, and may be communicated in any well known form (e.g., data or video streams) by any well known means of communicating data, such as analog antenna broadcast, analog cable, digital broadcast satellite (DBS), digital cable, switched digital video (SDV), local multipoint distribution system (LMDS), hybrid fiber coax (HFC), or the Internet. That is, it is understood that the media signals are communicated based on the head end system and the subscriber systems through one or more delivery networks, e.g., two-way cable network, analog cable network, digital cable network, the Internet, HFC network, SDV network, DBS network or wireless network such as MMDS (multichannel multipoint distribution system) or LMDS.

A preferred embodiment of the present invention will now be described in which the present invention is used to insert advertisements into television programming. However, it should be understood by persons of skill in the art that the invention can be used to insert any data into any other data stream. For instance, the invention can be applied to the Internet, streaming audio data, etc. It also may be applied to insert advertisements in the electronic program guides that often are provided in one channel of television programming and which commonly include advertisements in a portion of the display. It is equally applicable to inserting advertisements into recorded data, for example, from a VCR or PVR.

Preferably, the information stream includes particular time intervals which are dedicated for insertion of such external data. In the nomenclature of this specification, such designated intervals are termed avails. However, the invention also can be utilized to replace existing data in the data stream, if desired.

In accordance with the invention, various television programming channels or streams include open commercial breaks designated specifically for the insertion of ads by the television service provider. That is, the normal stream of information in the channel includes blank intervals (avails) so that an advertisement from a source separate from the channel data itself can be inserted into that interval.

In accordance with a preferred embodiment of the invention, the subscriber system has access to a plurality of advertisements which may be provided by the head end system, e.g., through one or more ad channels, which the subscriber system may retrieve in real time for insertion or store ahead of time and retrieve from memory when needed for insertion into an avail. Parent U.S. Provisional Patent Application No. 60/229,156 and U.S. patent application Ser. No. ______, entitled “Queue Based Advertisement Scheduling and Sales” (Docket No. T721-10) filed on Nov. 14, 2000 and owned by the same assignee of the present invention, disclose ad insertion methods and apparatus for ad delivery and insertion in accordance with the description above. The disclosures of these patent applications are hereby incorporated by reference.

Each subscriber system receives from the head end system or other external source a plurality of programming channels having avails, and inserts selected advertisements into the avails of the programming channels. Prior to inserting the advertisements into the avails, a display device operational status (DDOS) detector may detect whether or not the subscriber's display device (e.g., a TV) is operating, i.e., turned on. Such detection is known in the television art and can be accomplished in a variety of different ways, e.g., by detecting the operational current level of the display device. U.S. Pat. No. 4,723,302 to Fulmer et al., U.S. Pat. No. 4,764,808 to Solar, and U.S. Pat. No. 5,404,161 to Douglass et al., each of which is herein fully incorporated by reference, teach some of the different ways to detect whether or not the TV is turned on.

If the DDOS detector indicates that the display device is turned on, then the subscriber system proceeds with the insertion of ads into the avails and displays them on the subscriber's display device for viewing by the subscriber. However, if the DDOS detector indicates that the subscriber's display device is turned off, then the ad insertion is not performed since there is no purpose in inserting ads if no one is watching the display device. The ad insertion is simply delayed until a time when an avail is detected in a channel that the display device is tuned in and the DDOS detector indicates that the display device is turned on. The DDOS detector may reside in a set top box of the subscriber system or may be a separate device coupled between the set top box and the display device.

An ad processing unit of the subscriber system can determine in advance which ads are to be inserted and in what order based on one or more predetermined ad ordering and selection algorithms. Alternately, the ad insertion schedule or instruction for generating a schedule can be received from the head end (e.g, over a control channel) and stored in a memory associated with a set top box. Preferably, the ad insertion schedule includes an ordered list of ARLs (advertisement resource locators), each of which indicates to the STB a location from which a particular advertisement can be retrieved for insertion. The ad may be retrieved from the head end system or from a local storage or from a server to which the STB has access.

The subscriber system inserts the ads into the incoming programming channel according to the ad insertion schedule, if the DDOS detector indicates that the display device is turned on. This ensures that the inserted ads are actually displayed to the subscriber and increases the likelihood that the ads are viewed by the subscriber.

Furthermore, advertisements are no longer linked to any particular advertisement spot in any particular program because the subscriber system at each subscriber household inserts designated ads into the avails of the channel/program that the subscriber is currently watching, no matter what the channel/program may be. Therefore, a virtual roadblock can be set up whereby the subscriber will receive the designated ads in the designated order as avails occur in whatever programming he or she is viewing, regardless of the channel, program or time of day. In this manner, advertisers can more specifically reach their target audience while also being given a much higher level of confidence that their ads have actually been displayed to the target audience.

In accordance with one embodiment, the subscriber system includes a set top box (also referred to herein as local premises device) operatively coupled to the subscriber's display device such as a TV. The set top box includes the ad processing unit in addition to the components, such as a CPU, RAM, etc., typically found in conventional set top boxes (e.g., for cable TV, DBS, SDV systems). The ad processing unit may include the DDOS detector for detecting whether or not the display device is turned on.

The CPU in the set top box may maintain the ordered list of ARLs in the form of an advertisement queue in memory, e.g., RAM. At a minimum, each ARL may indicate the location of a particular advertisement in the system. The ARLs may also indicate other information about the advertisement, such as its length.

The ads that are pointed to by the ARLs preferably are stored in a memory local to the set top box. The local memory for storing the ads may comprise any high volume memory, including, but not limited to, RAM, magnetic hard drive, or optical storage media, such as optical disks. The local memory may be integral to the STB or separately located at a node on a communications network, such as on a remote server. In accordance with the invention, the set top box or the subscriber system includes some means by which it can determine the location and preferably the duration of avails. Several different means for performing this function are possible. For instance, PCT Patent Publication No. WO 99/66719, the disclosure of which is incorporated hereby by reference, discloses several means, such as detecting the black frames which television programmers typically provide in the video stream at the beginning of a television commercial avail. Alternatively, DVS-253 is a digital video standard for television promulgated by the Society of Cable and Television Engineers (SCTE) which provides for digital cue tones within the data stream indicating the start of commercial avails. In an analog television data stream, an avail indicator which can be detected by the set top box can be embedded within the vertical blanking interval of the incoming data stream. The indicator can include information indicating the duration of the avail.

In a preferred embodiment of the invention, the set top box transmits back to the head end or central office information concerning the ads that have been played at that subscriber location. In this manner, the television service provider can then bill the advertiser only for ads that were known to have been displayed on the display device. Thus, the advertisers will know that they are paying for an advertisement that was actually displayed on the subscriber's display device, rather than paying for the ad regardless of whether the display device is even operating.

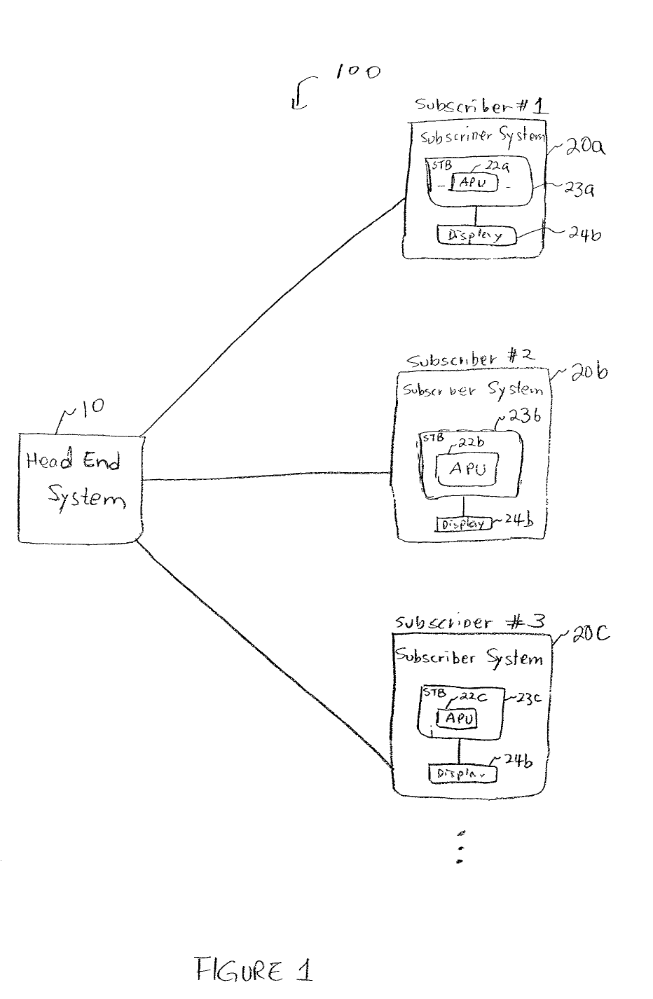

FIG. 1 is a block diagram illustrating an environment in which the present invention may be applied. As shown in FIG. 1, the environment 100 includes a head end system 10 and a plurality of subscriber systems 20a, 20b, 20c (collectively “20”), all operatively coupled. The head end and subscriber systems have been discussed above in detail. The head end system generates media signals (e.g., video signals including TV programming streams and/or advertisement signals) and transmits the media signals to the subscriber systems 20 on a plurality of channels.

The subscriber systems 20 receive the media signals from the head end system 10, select and process one or more channels of the media signals, and display the selected channels to the subscribers. In accordance with one embodiment, each of the subscriber systems 20 includes a set top box 23a, 23b or 23c, and a display device 24a, 24b or 24c coupled to the set top box. The set top boxes 23 correspondingly include advertisement processing units (APUs) 22a, 22b and 22c, each of which may include an advertisement insertion unit for inserting ads into the incoming channels of media programs. Each of the set top boxes 23 may further include components typically found in set top boxes, such as a tuner, a user interface, a CPU, ROM, RAM, etc. The set top boxes 23 or subscriber systems 20 may include additional memories such as optical disks or magnetic disks.

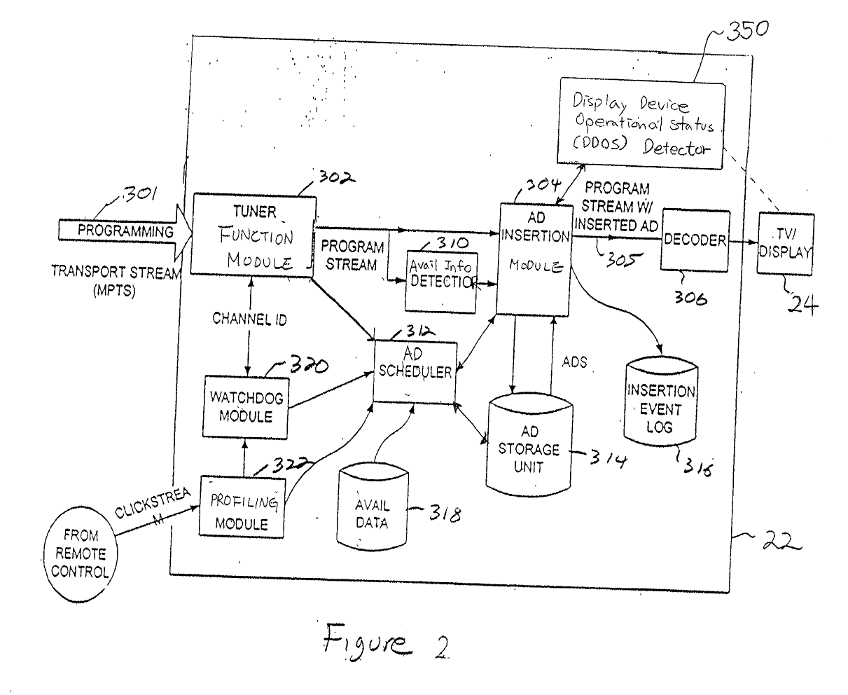

FIG. 2 is an exemplary functional block diagram of the ad processing unit (APU) 22 which may be included in the set top box 23 of the subscriber system 20 according to the present invention. As shown in FIG. 2, the APU 22 may include a tuner function module 302 for receiving at least one programming stream 301, an ad insertion module 304, a display device operational status (DDOS) detector 350, a decoder 306, an avail information detector 310, an ad scheduler 312, an ad storage unit 314, an insertion event log module 316, an avail data storage unit 318, a watchdog module 320, and a profiling module 322, all operatively connected. The APU 22 is operatively coupled to the display device 24, such as a TV, a computer monitor, etc., for displaying programming streams with inserted ads. The DDOS detector 350 may be directly or indirectly (e.g., inductively, or via other components) connected to the display device 24. This connection is represented by the solid and dotted lines in FIG. 2.

In accordance with one embodiment, the DDOS detector 350 determines the operational status of the display device 24, i.e., whether the display device 24 is turned on. This can be accomplished in a variety of ways. For example, one simple way is to detect the level of current flowing in the electric plug of the display device 24. If the display device 24 is turned on, a certain amount of current (i.e., operational current) will flow from the electric plug of the display device 24 into the circuitry of the display device 24 so as to operate the display device 24. If the display device 24 is turned off, only a very small amount of current should be flowing in the plug since the device 24 is turned off. In one embodiment, the display device 24 may be plugged into the set top box, in which case, the DDOS detector 350 may detect the level of current where the display device 24 is plugged into the set top box.

In accordance with one embodiment, the DDOS detector 350 may include a current level detector, coupled to the plug of the display device 24, for detecting the level of current flowing in the plug, and a comparator for comparing the detected current level with a predetermined threshold level and determining whether the display device 24 is turned on based on the comparison result. The components of the DDOS detector 350 needed to perform the functions set forth herein are well known in the art. The aforementioned U.S. Pat. No. 4,723,302 to Fulmer et al. teaches this type of detection.

Another way to detect whether the display device 24 is turned on is to use a local oscillator detector. If the display device 24 includes a tuner/receiver such as an internal TV tuner or an external cable tuner, the tuner typically includes a local oscillator for tuning the display device 24 to a particular channel or frequency. Since various frequencies designated for different channels are known, frequencies to which the local oscillator may be tuned are also known. Thus, by detecting frequency characteristics of the tuned signal of the local oscillator, a determination can be made as to whether or not the tuner, and thus the display device 24, is operating. For example, the DDOS detector 350 may include a local oscillator detector, coupled to the display device 24, for detecting a characteristic frequency of the tuned signal of the local oscillator of the display device 24 and comparing it with different frequencies corresponding to various channels, to make the detection. Different ways to detect local oscillator signals of a TV/STB receiver are disclosed in the aforementioned U.S. Pat. No. 5,404,161 to Douglass et al. The Douglass et al. patent also teaches that the tuned signal of the local oscillator can be detected from the antenna of the display device 24 (e.g., using a probe or inductive coupling on or near the antenna) or from the tuned signal reflected or leaking from the display device 24.

Still another way to detect whether the display device 24 is turned on is to use a chroma sub carrier detector. A color burst signal is a reference signal sent from a transmitter of TV signals to a TV receiver, e.g., the display device 24, to synchronize the receiver to the transmitter for accurate signal processing. The color burst signal includes about 8 to 11 cycles of chroma sub carrier signals having the frequency of 3.579545 MHZ set by the NTSC standards. The TV receiver receives the color burst signal and synchronizes the phase of the receiver based on the chroma sub carrier frequency provided in the color burst signal. Therefore, by detecting the strength of a chroma sub carrier signal from radiations (e.g., leakage signals) emitted by the display device 24, a determination can be made whether or not the television is operating. The aforementioned U.S. Pat. No. 4,764,808 to Solor teaches a detection method wherein a horizontal sweep signal directly derived from the color burst signal is used to detect the on/off operational status of the display device 24.

It should be apparent to one skilled in the art that the above described detection methods are mere examples and that other detection methods and devices are also possible. Different detection methods and devices may be utilized depending on the application of the invention.

In accordance with a preferred embodiment, the ad insertion module 304 inserts the advertisements into the programming stream only if the DDOS detector 350 indicates that the display device 24 is turned on.

The avail data storage unit 318 stores therein avail information (e.g., avail size, avail ID, etc.) directed to the avails of the upcoming programming channels, which may be known in advance since avails, such as commercial breaks for TV programs, are predetermined by the TV networks.

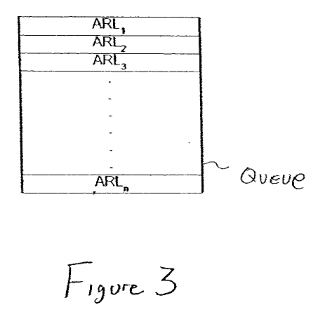

The ad scheduler 312 provides a schedule of ads to be inserted in the form of a queue or other forms. The queue, e.g., as shown in FIG. 3, is a stacked list of advertisement resource locators (ARLs) each indicating the location of a particular advertisement in the system, e.g., in the ad storage unit 314, and other information such as the duration of the stored advertisement. The ad scheduler 31 notifies the advertisement insertion module 304 of either the entire ad insertion schedule or the next advertisement to be inserted according to the ad insertion schedule.

In accordance with one embodiment, the ad scheduler 312 can determine in advance the ad insertion schedule based on scheduling instructions from the head end system 10 or predetermined scheduling algorithms. This can be accomplished as follows. The head end system 10 may transmit the avail information (e.g., timing/duration of upcoming avails, etc.) to the subscriber system 20 for storage in the avail storage unit 318. Based on the avail information in the storage unit 318 and other information (e.g., the time of day, characteristics of the subscriber), the scheduler 312 may prepare in advance the ad schedule in the form of a queue as illustrated in FIG. 3.

The operation of the invention using the detection by the DDOS detector 350 in accordance with one embodiment of the present invention is as follows. The tuner function module 302 receives the programing streams 301 from the head end system 10 or the like. In this exemplary embodiment, the received programming stream 301 is in the form of a DVB transport stream, i.e. a multiple program transport stream (MPTS), but can be in any other form known in the art. The tuner function module 302 extracts one channel of programs from the MPTS based on the channel selected by the current viewer.

The channel extracted by the tuner function module 302 carries avail time information (e.g., analog or digital cue tones) which is detected by the avail information detector 310 and indicates the location of an avail in the received program stream. Once the avail is detected based on the avail time information, the insertion module 304 turns to the DDOS detector 350 to determine if the display device 24 is operating, i.e., turned on. The DDOS detector 350 detects the on/off operational status of the display device 24 as discussed above and outputs a detection signal to the insertion module 304 indicating whether or not the display device 24 is turned on. If the detection signal indicates that the display device 24 is turned off, then ad insertion does not occur and the receiving programming stream may be discarded or stored for subsequent use.

On the other hand, if the detection signal indicates that the display device 24 is turned on, then the advertisement insertion module 304, according to the ad insertion schedule provided by the ad scheduler 312 and queue, requests a particular advertisement from the advertisement storage unit 314 which then sends the requested advertisement to the advertisement insertion module 304.

The advertisement insertion module 304 inserts or splices the received advertisement into the avail of the programming stream channel. The resulting program stream channel 305 with the inserted advertisement is decoded by the decoder 306 and sent to the display device 24 for display to the viewer of the display device 24.

The advertisement insertion module 304 generates and stores the advertisement insertion log of all insertion events in the log module 316. This is essentially the schedule of the ads that were inserted and displayed. The insertion logs are sent upstream to the head end system to be used for billing advertisers based on the ads that have been played at each subscriber's location. In this manner, the advertisers pay only for ads that were actually displayed on the subscribers' display devices.

It should be understood that the components shown in FIG. 2 represent functional aspects of the APU 22 and that each of these components may be implemented using analog circuits and/or digital circuits, including finite state machines, digital signal processors, computers, central processing units, application specific integrated circuits (ASICs), and programmed general purpose processors.

The invention has heretofore been described in connection with a simple embodiment in which ads remain in the queue until displayed. However, the advertisement schedule can be more than simply an order in which the ads are to be displayed (in avails in the tuned channel and only if the display device is on). Whether and when an ad is to be displayed may be based on additional criteria, including, but not limited to, time of day, type of program, and a probabilistic determination of the person or type of person watching the television at any given instant. Some such additional criteria and/or how they can be used to schedule ads are discussed in aforementioned U.S. Provisional Application No. 06/229,156 on which the present application is based, and PCT Patent Publication No. WO 033233A1, entitled “Subscriber Identification System” and assigned to the same assignee as the present invention (corresponding to U.S. patent application Ser. No. 09/452,893, filed on Dec. 2, 1999), the disclosure of which is incorporated herein by reference. See also aforementioned U.S. patent application Ser. No. ______, (Docket No. T721-10) entitled “Queue Based Advertisement Scheduling and Sales” assigned to the same assignee as the present application, for discussion of queue ordering that incorporates such criteria.

That is, certain advertisers may wish their ads to be displayed only if certain additional criteria are met. In some cases the advertisers criteria may be such that, if the criteria do not occur, the ad may be deleted from the schedule and never displayed. In other cases, the ad may be circulated back to the bottom of the queue or may remain at the top of the queue to be the first ad displayed when the criteria are met. Alternately, the ad may remain in the queue (either at the top or recirculating) until either displayed or a certain amount of time elapses, whichever occurs first. The possibilities are endless. If the ad is never displayed, presumably, the advertiser would not be charged for it or might be charged a nominal fee for processing of the ad even though it was not played. Alternately, the advertiser may be charged a higher rate per displayed ad if the advertiser requires certain types of additional criteria to ad display.

The present invention can readily be applied to recorded programming as long as the recorded program is played back through the subscriber system so that the advertisement processing unit may insert the advertisement. The invention can also be applied to any information stream regardless of source as long as the information stream passes through the advertisement processing unit. Thus, for instance, the invention is equally applicable to analog cable, regular earth-based broadcast television, the Internet, a read-out from any type of memory device, including compact disks, digital video disks, other optical media, magnetic disks, ROM, RAM, etc.

Overall, the present invention can readily be applied to any advertisement insertion system for inserting advertisements into programming (e.g., recorded programming, programming streams, etc.), which is coupled to a display device. The display device includes any device that propagates information, e.g., by displaying information visually, playing the information audibly, or any other ways.

In accordance with the present invention, targeted advertisements are inserted into the programming stream only if the subscriber's display device is turned on to actually display the inserted advertisements. In this manner, advertisers can more specifically reach their target audience while also being given a much higher degree of assurance that their ads have actually been displayed to the target audience.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. A method for addressing advertisements to a subscriber of a communications network, the method comprising the steps of:
determining whether or not a display device of the subscriber is operating; and
inserting the advertisements into at least one media stream if the determining step determines that the display device is operating.

2. The method of claim 1, further comprising:
displaying the at least one media stream with the inserted advertisements on the display device.

3. The method of claim 2, further comprising:
storing a record of the inserted advertisements; and
transmitting the record to a designated location at the communications network.

4. The method of claim 1, wherein the determining step includes:
detecting a level of electrical current flowing to the display device; and
determining whether or not the display device is operating based on the detected current level.

5. The method of claim 1, wherein the determining step includes:
detecting frequency characteristics of a tuned signal of a local oscillator of the display device; and
determining whether or not the display device is operating based on this detection.

6. The method of claim 1, wherein the determining step includes:
detecting a strength of a chroma sub carrier frequency signal from radiations emitted by the display device; and
determining whether or not the display device is operating based on this detection.

7. The method of claim 1, further comprising:
discarding the at least one media stream if the determining step determines that the display device is not operating.

8. The method of claim 1, further comprising:
identifying a predetermined order in which the advertisements are to be inserted into the at least one media stream; and
storing an ordered list corresponding to the identified order, wherein the advertisements are inserted into the at least one media stream according to the ordered list.

9. The method of claim 8, wherein, in the storing step, the ordered list is stored in a queue in a set top box assigned to the subscriber.

10. The method of claim 9, wherein the ordered list stored in the queue is a stacked list of advertisement resource locators (ARLs) indicating to locations where the advertisements are stored.

11. The method of claim 1, further comprising:
prior to the inserting step, receiving the at least one media stream from the communications network.

12. The method of claim 11, wherein the communications network is a television service network.

13. The method of claims 11, wherein the communications network is an Internet service network.

14. The method of claim 11, wherein, in the receiving step, the at least one media stream is received by one of the following means: analog cable, digital broadcast satellite (DBS), digital cable, switched digital video (SDV), digital subscriber line (DSL), very high speed digital subscriber line (VDSL), hybrid fiber coax (HFC)cable, or the Internet.

15. The method of claim 1, further comprising:
storing, locally to the subscriber, the advertisements to be inserted into the at least one media stream.

16. The method of claim 15, wherein the storing step stores the advertisements in a set top box assigned to the subscriber.

17. The method of claim 15, wherein the storing step stores the advertisements at a server on the communications network.

18. A subscriber system for addressing advertisements to a subscriber of a communications network, the system comprising:
first means, coupled to a display device associated with the subscriber, for determining whether or not the display device is operating; and
second means, coupled to the first means, for inserting the advertisements into at least one media stream responsive to the first means determining that the display device is operating.

19. The system of claim 18, wherein the display device displays the at least one media stream with the inserted advertisements.

20. The system of claim 19, further comprising:
third means, coupled to the second means, for storing a record of the inserted advertisements.

21. The system of claim 19, wherein the first means detects a level of electrical current flowing to the display device, and determines whether or not the display device is operating based on the detected current level.

22. The system of claim 19, wherein the first means includes a local oscillator detector for detecting frequency characteristics of a tuned signal of a local oscillator of the display device and for determining whether or not the display device is operating based on this detection.

23. The system of claim 19, wherein the first means includes a chroma sub carrier detector for detecting a strength of a chroma sub carrier frequency signal from radiations emitted by the display device and for determining whether or not the display device is operating based on this detection.

24. The system of claim 19, wherein the first means includes an inductive coupling for detecting whether or not the display device is operating.

25. The system of claim 19, wherein the second means discards the at least one media stream if the first means determines that the display device is not operating.

26. The system of claim 19, further comprising:
fourth means, coupled to the second means, for identifying a predetermined order in which the advertisements are to be inserted into the at least one media stream, and for storing an ordered list corresponding to the identified order, wherein the second means inserts the advertisements into the at least one media stream according to the ordered list.

27. The system of claim 26, wherein the ordered list is stored in a queue memory, which identifies a stacked list of advertisement resource locators (ARLs) indicating locations where the advertisements are stored.

28. The system of claim 18, further comprising:
fifth means, coupled to the second means, for receiving the at least one media stream from the communications network and directing the at least one media stream to the second means.

29. The system of claim 28, wherein the communications network is a television service network.

30. The system of claims 28, wherein the communications network is an Internet service network.

31. The system of claim 28, wherein the fifth means receives the at least one media stream by one of the following means: analog cable, digital broadcast satellite (DBS), digital cable, switched digital video (SDV), digital subscriber line (DSL), very high speed digital subscriber line (VDSL), hybrid fiber coax (HFC)cable, or the Internet.

32. The system of claim 18, further comprising:
sixth means, coupled to the second means, for storing therein the advertisements to be inserted into the at least one media stream.

33. The system of claim 32, wherein the sixth means is a memory in a set top box assigned to the subscriber.

34. The system of claim 32, wherein the sixth means is a server on the communications network.

35. A method for addressing information to a viewer, comprising the steps of:
transmitting the information to a local premises device capable of storing the information;
storing the information in the local premises device;
determining whether a display device associated with the local premises device is operating; and
inserting the information into a video stream being transmitted to the local premises device if the determining step determines that the display device is operating.

36. The method of claim 35, further comprising:
continuing to store the information in the local premises device without inserting the information into the video stream, if the determining step determines that the display device is not operating.

37. The method of claim 35, wherein the video stream is a television programming stream.

38. The method of claim 35, wherein the information includes an advertisement.

39. The method of claim 35, wherein the local premises device is a set top box assigned to the viewer.

40. A system for addressing information to a viewer, comprising:
means for transmitting the information to a local premises device capable of storing the information;
means for storing the information in the local premises device;
means for determining whether a display device associated with the local premises device is operating; and
means for inserting the information into a video stream being transmitted to the local premises device if the determining means determines that the display device is operating.

41. The system of claim 40, wherein the storing means continues to store the information in the local premises device without inserting the information into the video stream, if the determining means determines that the display device is not operating.

42. The system of claim 40, wherein the video stream is a television programming stream.

43. The system of claim 40 wherein the information includes an advertisement.

44. The system of claim 40, wherein the local premises device is a set top box assigned to the viewer.
